(19) United States
(12) Patent Application Publication
(10) Pub. No.: US 2009/0138439 A1
(43) Pub. Date: May 28, 2009

(54) Systems and methods for location based Internet search

(75) Inventors: Allan Yeung, Los Angeles, CA (US); Christian A. Buerger, Woodland Hills, CA (US); Hyewon Kim, Glendale, CA (US); Eugene Koh, Brookline, MA (US)

Correspondence Address: FENWICK & WEST LLP, SILICON VALLEY CENTER, 801 CALIFORNIA STREET, MOUNTAIN VIEW, CA, 94041, US

(73) Assignee: Helio, LLC., Los Angeles, CA (US)

(21) Appl. No.: 11/986,833

(22) Filed: Nov. 27, 2007

(51) Int. Cl. G06F 17/30

(52) U.S. Cl. 707/3; 707/E17.001

(57) ABSTRACT

A method of conducting a search on a mobile device, the mobile device capable of communicating with a content server. The method includes the steps of: initiating a search query using a browser on the mobile device, the search query having a search string; automatically obtaining location information of the mobile device; simultaneously transmitting the location information and the search query to the content server; and receiving a search result from the content server in response to the search query, wherein the step of automatically obtaining location information is in response to the step of initiating the search query.

### FIELD OF THE INVENTION

The invention relates to the field of network-based searching performed on a mobile device. Specifically, the invention relates to systems and methods for browser-based point of interest, and contextually relevant searching using automatic location determination.

### BACKGROUND OF THE INVENTION

Virtually all of the mobile devices today are equipped with web browsers that allow users of the devices to browse the Internet and search for information from the Internet. Most of the internet browsers on mobile devices are based on the Wireless Application Protocol (“WAP”) as well as HTML (Hyper Text Markup Language). A mobile browser is a simplified version of the regular computer based web browser (i.e., the Internet Explorer from Microsoft Corporation). Mobile browsers are suited for displaying webpages on the relatively small screens of mobile devices without sacrificing too many of the functionalities provided by a PC browser.

In addition, mobile devices are equipped to provide information on their real time locations. Cell-ID can be used to estimate the location of a mobile device by using a cell-ID of a cell tower. Almost all cellular phones can be located by their cell-IDs. More sophisticated mobile devices incorporate Global Positioning System (GPS) technology. GPS uses a satellite network to transmit signals to individual GPS receivers on the ground which then calculates receiver coordinates based on these signals. The software on the mobile device then converts these coordinates to a user friendly format, such as a pointer on a map, to be displayed to the user.

The web access and location determination capabilities of a mobile device are both useful tools for the user of the device. However, currently, browser-based applications are limited when it comes to location-based searching. For example, to conduct a real time point of interest search with a mobile device, a user has to go through the steps of opening the browser on the device, selecting a search page and typing in one's current location information, such as their zip code. To accomplish these steps, scrolling and typing on the relatively small, sometimes tiny, keypads of most of the mobile devices is required. As a result, this process is often a frustrating experience for the users, discouraging the users due to poor usability.

Other mobile devices such as in-car navigation systems provide real-time point-of-interest searches based on GPS coordinates. However, one of the disadvantages of these systems is that they do not provide direct access to the Internet. As a result, since pre-fetched data is used, these applications are usually limited by the scope of the searches and the search results. Accordingly, a system and method is desired to provide mobile device users a faster and more user friendly way to conduct a customized location-based search using existing browsers on the mobile device.

### SUMMARY OF THE INVENTION

In one aspect, the invention relates to a method of conducting a search on a mobile device, the mobile device capable of communicating with a content server. The method includes the steps of: initiating a search query using a browser on the mobile device, the search query having a search string; automatically obtaining location information of the mobile device; simultaneously transmitting the location information and the search query to the content server; and receiving a search result from the content server in response to the search query, wherein the step of automatically obtaining location information is in response to the step of initiating the search query.

In another embodiment, the method further includes the step of incorporating user defined search terms in the search query. In another embodiment, the step of initiating a search further includes the steps of opening the browser on the mobile device and clicking on a link displayed on the browser. In yet another embodiment, the location information is in the format of GPS coordinates. In yet another embodiment, the location information of the mobile device is based on the cell-ID of the mobile device. In yet another embodiment, the location information is stored on the mobile device. In yet another embodiment, the method further includes the step of obtaining user consent for using the location information of the mobile device in the search.

In another aspect, the invention relates to a mobile device adapted to conduct a location based search, the mobile device capable of communicating with a content provider. The mobile device includes a browser for initiating a search query; a location determining module for obtaining location information of the mobile device, the location determination module is in communication with the browser; a data formatting module for formatting the location information and incorporating the formatted location information in the search query; and a communication module for transmitting the search query to the content provider and receiving a search result from the content provider.

In another embodiment, the mobile device further includes a user input module adapted to receive user defined search terms. In another embodiment, the location information is in the format of GPS coordinates. In yet another embodiment, the location information of the mobile device is based on the cell-ID of the mobile device. In yet another embodiment, the location information of the mobile device is stored on the mobile device. In yet another embodiment, the mobile device further includes a user consent verification module for verifying user consent for using the location information of the mobile device in the search.

In yet another aspect, the invention relates to a method of conducting a search using a browser on a mobile device. In one embodiment, the mobile device is capable of communicating with a content server. The method includes the steps of entering a search query at a search prompt; automatically obtaining location information of the mobile device in response to entry of the search query; storing the location information and search query in a container; transmitting the container to the content server; querying the content server for point of interest data based on contents of container; and retrieving point of interest data from the content server.

In another embodiment, the method further includes the step of obtaining user consent for using the location information of the mobile device in the search. In yet another embodiment, the method further includes the step of converting the location information into a converted format. In yet another embodiment, the converted format is a XML entity. In still yet another embodiment, the converted format includes GPS coordinates.

The methods are explained through the following description, drawings, and claims.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1A is a functional block diagram that illustrates the component of an exemplary system that includes location determining network interface component for practicing an embodiment of the present invention;

FIG. 1B is a block diagram that illustrates a mobile device in communication with different networks, according to an embodiment of the invention;

FIG. 2 is a block diagram illustrating the components of a mobile device which may be used to obtain location information and use the information in an network-based search, according to an embodiment of the invention;

FIG. 3 is a flow chart that illustrates the steps of conducting a location based search, in accordance with an embodiment of the present invention; and

FIG. 4 is a series of exemplary screen shots illustrating the steps of conducting a location based search on a mobile device, in accordance with an embodiment of the present invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

In the following discussion of illustrative embodiments, a “mobile device” includes, without limitation, mobile phones, remote control devices, personal digital assistants, hand-held computers, ultra-mobile personal computers, and the like.

Embodiments of the present invention allow a user to perform location based searches, using a network, such as the Internet, on a mobile device without manually specifying the device's present location. Currently, to conduct location based point-of-interest search on a mobile device, the user has to define the search terms and enter his location information in the format of a zip code or a street address, sometimes in two separate steps, before actually submitting the search. The extra typing and scrolling actions required on the part of the user make the process intolerable and sometimes unworthy of the effort. In addition, given the relatively slow response time of the browsers running on mobile devices, it further prolongs the response time required to obtain the desired search results. To improve usability and response time, the system and methods described and recited herein eliminate unnecessary steps in the search process by utilizing technologies that exist on mobile devices. Specifically, the location determination functions available on most of the current generation of mobile devices can be used to support the embodiments described herein.

Mobile devices can obtain their location information in a number of different ways, depending on their designs. Some mobile devices are equipped with cell-ID based location determination capability which identifies device position relative to a given cell tower. More accurate and advanced location determining mechanisms include Mobile Station Assisted Positioning and Mobile Station Based Methods that require the mobile device to have a build-in GPS receiver to receive direct communication from the GPS satellites. However, despite having such capabilities, the mobile devices on the market today only offer a limited number of applications that use location information. Some of these applications include, for example, buddy lists, package tracking programs and GPS enabled maps. To date, there has not been any browser based search engine that utilizes the available location information of the mobile devices.

One embodiment of the present invention incorporates location information for network-based searches on a mobile device where the search data is transmitted in a containerized form. Mobile device users frequently search for weather forecast, restaurants, movies listings, or the closest location of a particular retail store. The results of each of these searches depend on the real-time location of the user. Instead of manually typing in a street address/zip code on a particular weather or movie site every time a user visits these sites, one embodiment of the invention provides systems and methods for automatically obtaining and incorporating location information, and thus, significantly improves the response time and user experience. This enhancement to the user experience occurs without adding much cost to the hardware and service. In addition, embodiments of the invention make it possible for a mobile device user to perform a location based search even when the user does not know their location.

As a general overview, in one embodiment, a user of a mobile device initiates a search by opening the browser on the mobile device and selecting a search page or search application. When the user submits the search query with specific location data container, the browser automatically initiates a location determination process to obtain location information of the mobile device. The location information in latitude, longitude and altitude coordinates (or other spatial location data) is then captured in a container. That is, in one embodiment, (1) device location data and (2) search data are containerized. The container contents, including user defined search terms, or translations thereof are then submitted to the content server. In response to some or all of the container's contents, the content server generates and executes a search query based on the location information and search terms. Search results are then retrieved and displayed on the mobile device.

A container base approach is advantageous because it allows the browser to obtain location information and also provides a suitable architecture for supporting location based systems (“LBS”). Such browser based search applications generally require significantly less time and are much less expensive to implement than non-browser based search applications. In addition, the browser based search application can be easily integrated with other web based applications to provide additional capabilities since various web based applications may be hosted on the same web server. Further, browser based applications using containerized data can be updated remotely without requiring any upgrades to the mobile device itself.

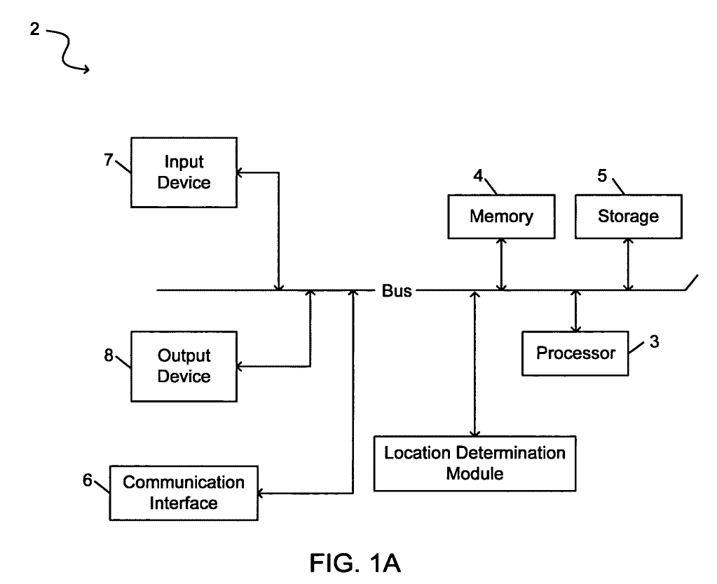

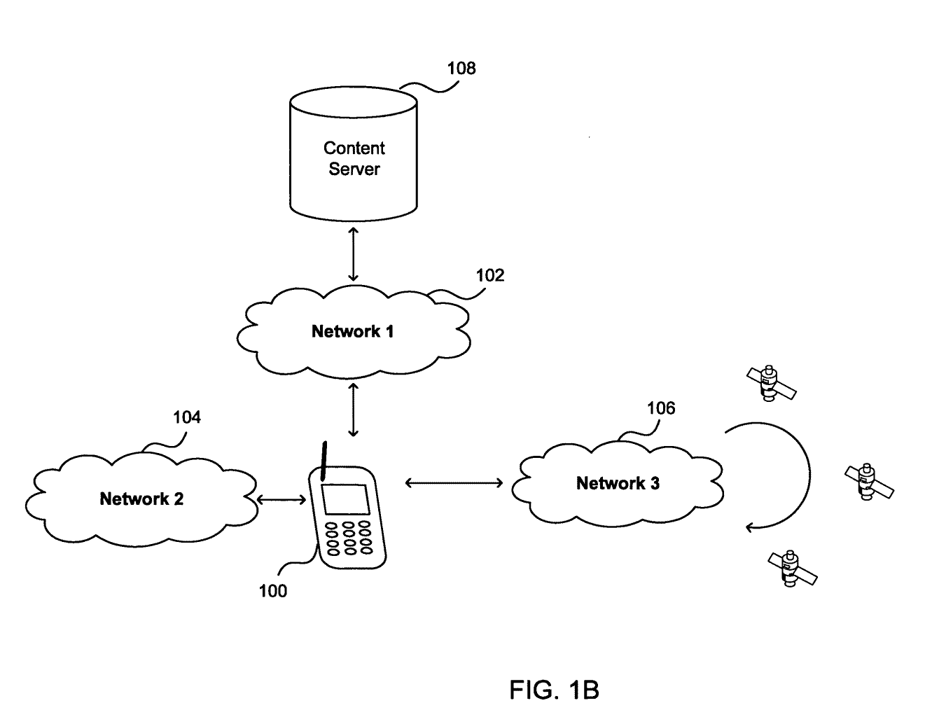

FIG. 1A is a functional block diagram that illustrates the components of an exemplary mobile device 2 for practicing an embodiment of the present invention. Mobile device 2 preferably includes a processing unit or processor 3, a system memory 4, a disk storage 5, a communication interface 6, an input device 7, an output device 8, and a system bus 9. System bus 9 couples system components including, but not limited to, system memory 4 to processing unit 3. The processing unit 3 can be any of various available processors. A location based system (“LBS”) module 10 is also shown. The LBS module 10 can include various data elements and programs suitable for performing the process steps and calculations outlined below with respect to obtaining location information of the mobile device. For example, the LBS module may correspond to a cellular LBS module, while other components of the interface (not shown) may correspond to Wi-Fi LBS and traditional GPS or enhanced GPS modules, respectively. In one embodiment, the LBS module 10 translates, encodes, and/or decodes containerized data. This LBS module may also contain cached and/or user provided location information.

Input device 7 may be a keyboard, thumbboard, or touchscreen (for use with a stylus) that are used to receive data from a user. In addition, input device 7 can also include a plurality of other inputs or controls for adjusting and configuring one or more aspects of the present invention including voice commands. Output device 8 may be a display device, such as an LCD or LED display screen, that can display one or more display objects (not shown) such as configurable icons, buttons, input boxes, menus, tabs, key labels and so forth having multiple configurable dimensions, shapes, colors, text, data and sounds to facilitate operations with mobile device 2. In particular, the output device is also adapted to display a browser containing webpages. In one embodiment, the browser may be a WAP based browser capable of displaying mobile internet sites. In another embodiment, the browser may be a HTML enabled mobile browser.

Communication interface 6 facilitates data exchange over a variety of wireless networks. As shown, the communication interface 6 can include a plurality of components or operational features that allow the mobile device 2 to communicate with a content server (not shown), transmit containers of search and location data, and retrieve information from the content server. The hardware and software necessary for connection to the communication interface 6 includes, for exemplary purposes only, internal and external components that transmit and receive data wirelessly using a plurality of standard protocols including, for example, GSM, CDMA, W-CDMA, Bluetooth, Wi-Fi, IrDA, WiMAX, WiBRO or through other known wireless standards.

Storage 5 may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (“EEPROM”), magnetic disk storage or other magnetic storage devices, or any other medium that can be used to store digital information on a mobile device.

FIG. 1A describes software that acts as an intermediary between users and the basic resources described in mobile device 2. Such software preferably includes an operating system. The operating system, which can be resident in storage 5, acts to control and allocate resources of mobile device 2. System applications take advantage of the management of resources by the operating system through program modules and program data stored either in system memory 4 or on disk storage 5. Furthermore, the present invention can be implemented with various operating systems or combinations of operating systems. The methods of conducting a point-of-interest search on a mobile device by automatically incorporating location data of the mobile device can be implemented in software resident in memory that interacts with the communication interface and processor and/or other device components as appropriate. The LBS module 10 or other components of a mobile device can be used to implement this position determining process.

The computer readable medium tangibly embodies a program, functions, and/or instructions that cause the computer system to operate in a specific and predefined manner as described herein. Those skilled in the art will appreciate, however, that the process described below relating to location detection and web application development as well as other features recited herein, may be implemented at any level, ranging from hardware to application software and in any appropriate physical location. For example, the present invention may be implemented as software code to be executed by mobile device using any suitable computer language and may be stored on any of the storage media described above, or can be configured into the logic of mobile device 2. Such software code may be executed by mobile device using any suitable computer language such as, for example, Java, Javascript, C++, C, C#, Perl, Visual Basic, Transact/Structure Query Language (T/SQL), database languages, assembly, microcode, and/or other languages and tools, as well as various system-level SDKs.

These are representative components of a mobile device whose operation is well understood. Furthermore, those of ordinary skill in the art will appreciate that mobile device 2 of FIG. 1A is exemplary only and that the present invention can operate within a number of different mobile devices.

FIG. 1B illustrates the components of an exemplary mobile device 100 for practicing an embodiment of the present invention. In the illustrated embodiment, the mobile device 100 preferably includes a display, a processor, a keypad, and one or more network interface components adapted to access multiple networks using a network interface/communication interface.

Specifically, FIG. 1B illustrates a mobile device 100 in communication with multiple networks 102, 104, 106. In various embodiments, the mobile device 100 may be a mobile phone (as illustrated), personal digital assistants, hand-held computers, ultra-mobile personal computers, and the like. The mobile device 100 includes a communication subsystem adapted to communicate with the multiple networks 102, 104, and 106. An example of such a device is a dual mode 802.11/cellular phone, which is capable of receiving Wi-Fi signals in addition to the basic cellular network signals.

As illustrated, the first network 102 connects the mobile device 100 to a content server 108 having access to a database of searchable information. The first network 102 may be any type of cellular network adapted to transmit text and/or voice data using one or more of the available wireless protocols. In one embodiment, the first network 102 is the Internet and the mobile device 100 is connected to the Internet via a Wi-Fi connection. In this embodiment, the content server 108 may be a search engine (i.e., Google.com) open for public access. In another embodiment, the content server 108 may be a secured server dedicated for a selected group of users having subscription to a particular wireless service. Accordingly, the first network 102 may be a Virtual Private Network or other similar closed network.

The content server 108 is capable of accepting and processing requests in HTML, XHTML, WML or other similar Markup languages submitted through the browsers of the mobile devices 100. Depending on the software adopted in each mobile device, the browsers on the mobile device may be able to handle one or more of the above-mentioned markup languages. In addition, the content server 108 is adapted to parse and extract containerized location data and search terms embedded in those requests and use the extracted information to define a search query. In one embodiment, the content server 108 may include a web server (i.e., Apache HTTP server, Microsoft Internet Information Server) and a database (i.e., Oracle, Microsoft SQL Server) in communication with each other. For example, a retailer chain may have a dedicated web server for hosting its website and a database containing the address of all of its store locations. A search for the closest store in the chain by a mobile user is processed by the web server which, in response, queries the database and generates a list of the store addresses closest to the user location. In general, the content server 108 is responsible for providing search results, particularly location based search results, to the mobile devices users upon their requests.

Still referring to FIG. 1B, the other two networks 104, 106 shown are associated with at least one location based service. Although embodiments of the present invention only require one location-based service network 102 accessible to the mobile device 100, the capability of connecting to multiple location-based service networks provides better location based service coverage for the mobile device 100. Given the geographic placement of Wi-Fi hotspots and the cells associated with different towers and base stations used for cellular phone service, both cellular services and Wi-Fi services can be used as location determination services in accordance with the teachings described herein. Thus, a mobile device with GPS, Wi-Fi, and cellular capabilities can act as a multi-mode location determining device. However, the term dual mode or multi-mode is not limited to a particular grouping of networks or service types. Thus, multi-mode can refer to the ability of the mobile device to access two or more location determination services such as a location-based service and/or their associated location data providing services.

Each of the networks 104, 106 provides a location-based service that allows the user of the mobile device 100 to determine his or her current location and, optionally, calculate directions to specified destinations. The networks 104, 106 may each utilize different Open Systems Interconnection (OSI) Layer 1 and Layer 2 technologies. For example, the second network 104 may be an IEEE 802.11 Wi-Fi network and the third network 106 may be a cellular network that utilizes the devices position to different cells to generate positional information, or it may be an enhanced service that combines cellular data with GPS data to provide location service. The location information may come from any of the networks based on the availability of the networks and preprogrammed fallback logics that are designed to optimize the location service.

When the device 100 is within a particular range of some or all of the networks 104 and 106, the device 100 is programmed to automatically select the optimized network based on a number of criteria, such as cost of service, accuracy and response time, associated with the networks. As illustrated in FIG. 1B, either the Wi-Fi network 104 or the cellular GPS network 106 is sufficient to provide location information to the mobile device 100 when available. The Wi-Fi network 104 determines the location of the mobile device by calculating the relative distances between the device and multiple Wi-Fi hotspots. In comparison, the cellular GPS network 106 utilized GPS satellites to provide location coordinates to the mobile device. For the present invention, the mobile device has the capability of obtaining its location information for use in the searches.

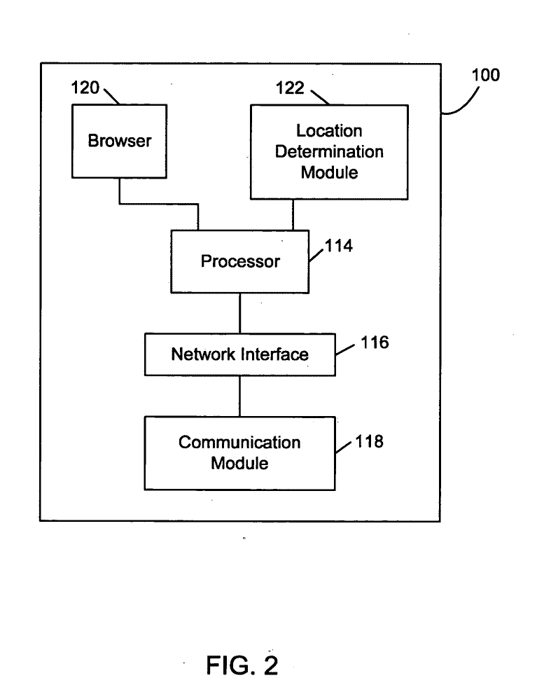

FIG. 2 illustrates components of an exemplary device 100, such as a cellular phone, suitable for retrieving location data and automatically incorporating the data as a part of a search query to be transmitted to an external content server (not shown), according to one embodiment of the invention. Referring to FIG. 2, the device 100 includes a processor 114, a display 120 for displaying a browser, a location determination module 122, an optional network interface component 116 and a communication subsystem 118. In one embodiment, the network interface component can be part of, or comprise the entire subsystem 118.

In one embodiment, the processor 114 processes a user request to conduct a search, displays a browser containing at least one webpage to the user, receives additional user specified search terms from the browser, calls the location determination module 122 to obtain current location coordinates, captures and reformats the coordinates, and transmits the formatted coordinates with the additional user input to an external content server through the communication module 118. The optional network interface component 116 serves as a gateway between the processor 114 and the communication subsystem 118. The network interface component 116 can convert data including location coordinates and search strings into the correct data format compatible with the wireless network bridging the mobile device 100 and the content server.

In various embodiments, the network interface component 116 may employ a variety of GPS-based, cellular and Wi-Fi based location determination technologies and systems in conjunction with the existing cellular location determination technologies. Location determination technologies include, but are not limited to, Cell-ID, Mobile Station Based Method (MS-Based) and Mobile Station Assisted Positioning Mode (MS-Assist).

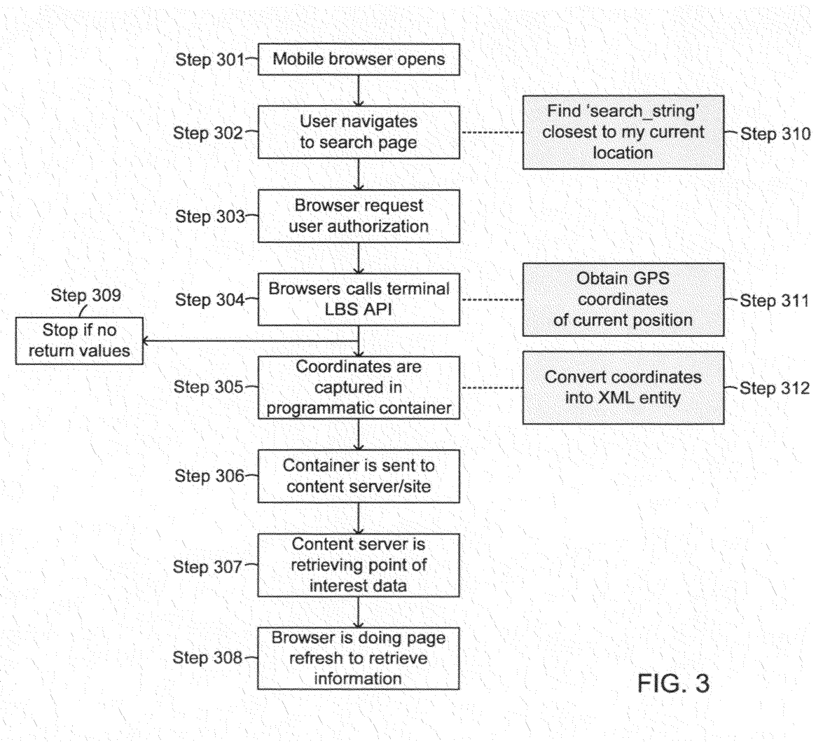

FIG. 3 is a flow chart that illustrates the steps of conducting a location based internet search, in accordance with an embodiment of the present invention. In operation, a user of a mobile device opens a browser on the mobile device by selecting an option from a menu or clicking on an icon on the idle screen of the device (Step 301). Other means of user input may be used to interact with the mobile device. For example, a mobile device equipped with voice recognition technology may allow its user to enter commands by speaking directly to the device without using a keypad. Upon opening, the browser displays a default page. The default page of the browser may include a list of links to websites most frequently visited by the user of the device, or may be set to one particular mobile website, such as Yahoo.com.

The user may then navigate to a search page (Step 302). Optionally, this special search page may be the default page of the browser. In one embodiment, the search page includes a text field for the user to type in a search string, such as “Target store,” “gas station,” “Marriott,” or “Pizza Hut.” In other embodiments, the search page may also display a number of the most frequently searched items as icons or links for direct user selection. Preferably, a text field or other means for receiving user defined search string is available on the search page because one of the advantages of the invention is to give users the freedom to search for anything on the Internet rather than limit them to only a few search categories. In one embodiment, the search page is the home page of a search engine (i.e., Google.com), given the user the ability to search for almost any information available on the Internet. The resulting information will be made contextually relevant, based on the addition of the location coordinates generated in the search string, via the proposed mechanisms. The search page may be generated in HTML, XHTML, or any other markup languages. An example of the HTML code of the search page is provided below:

```
    <html>
      <body>
        <a href=“http://searchprovider.com/searchdetail?lat=&lat;&lng=
&lon;”>Click here for Search Result based on my current
location</a><p/>
      </body>
    </html>
```

Because of privacy concerns relating to disclosing user location to a third party, such as the content server, the browser may request user authorization before initiating the location determination process (Step 303). In one embodiment, a popup in the browser may be used to display a warning message to the user and prompt the user for confirmation on the disclosing of his location. According to an embodiment of the invention, the search page is specially marked so that as it is loaded in the browser in response to a user action, the browser initiates a call to the terminal LBS API to obtain the current location data of the mobile device (Step 304). The LBS API may be stored in the memory of the device or in the location determination module and allows the browser to communicate with the location determination module.

Upon receiving user confirmation, the browser proceeds with the location determination process. In one embodiment, the browser sends a query to an application platform on the location determination module by calling a device control function (e.g., MC-ioDevControl). Depending on the type of location service requested, the location function may obtain location information using Cell ID, MS-Based or MS-Assisted technologies. If Cell-ID is chosen, the device does not have to start a GPS session because Cell-ID of the closest cellular tower is already stored in the baseband process for RF processing. In comparison, if MS-Based or MS-Assisted methods are used to obtain updated location information, the browser first tries to verify whether the corresponding GPS module resource is available or not. If the resource is available, the browser proceeds to open a session with the module to acquire GPS coordinates. In one embodiment, the device control function, “MC_ioDevControl”, has the following structure:

M_Int32 MC_ioDevControl(M_Int32 fd, M_Char*cmd, void*param1, void*param2)

Where fd is the Device ID, cmd is the string representing the type of operation to be implemented on the device, and param1 and param 2 are parameters to be passed to the relevant operation of the device or buffer pointer where the result value of the operation is stored. Variations of this device control function may be used to obtain the logical channel number of the currently allocated UICC when used only for a WCDMA terminal.

In this embodiment, the application platform sets the variable cmd in MC_ioDevControl to “GETINFO” when requesting new location information. The coordinates returned from the device are, in one embodiment, raw GPS values stored in a variable (e.g., MC_LbsLocInfo) that can be translated into standard location format. Alternatively, the application platform may update the current location coordinates by calling the same function with an “UPDATE” command and setting “param1” to MC_LbsLocDeterminatorOption. In one embodiment, the structure of MC_LbsLocDeterminatorOption is as follows:

option.freset=0;
option.SvcType=2;
option.FixNum=1;
option.FixPeriod=1;
option.OptInfo=0;
option.OperMode=1;
option.SessionType=1;
option.FixNum=1;
option.FixPeriod=60;
option.Privacy=0;
Table 1 lists the possible values, detailed descriptions and output messages for each of the parameters in the MC_LbsLocDeterminatorOption data structure.

| Parameter | Value | Detail | Output Message |
|---|---|---|---|
| fReset | TRUE | While GPS is in operation and | fReset = true |
| | | GPS session is established, | |
| | | terminates the current working | |
| | | GPS and GPS session in force and | |
| | | then reset the GPS. | |
| | FALSE | While GPS is in operation and | fReset = false |
| | | GPS session is established, | |
| | | maintain current working GPS | |
| | | and GPS session and then reset | |
| | | the GPS. Resetting GPS could be | |
| | | failed. | |
| SvcType | 0 | Requesting position calculation | SvcType = MsAssistedGPS |
| | | for MS Assist | |
| | 1 | Requesting position calculation | SvcType = MsBasedGPS |
| | | for MS Based | |
| | 2 | Requesting Cell info. Without IS- | SvcType = Cell-ID |
| | | 801-1/A session, CDMA | |
| | | parameter will be sent. | |
| PDEUrl | Text/Number | PDE IP | PDEIP = xxx.xxx.xxx.xxx |
| PDEPort | Integer | PDE TCP/IP port | PDEPort = 8300 |
| OptInfo | 0 | Requesting Longitude and | OptInfo = Location2D |
| | | Altitude/First Fix Timeout = 30 | |
| | 1 | Requesting Longitude and | OptInfo = Heading |
| | | Altitude + Heading info/First Fix | |
| | | Timeout = 30 | |
| | 2 | Requesting Longitude and | OptInfo = Speed |
| | | Altitude + Heading info + Speed | |
| | | info/First Fix Timeout = 30 | |
| | 1000~1255 | Requesting Longitude and | |
| | | Altitude + Heading info + Speed | |
| | | info/First Fix Timeout = (OptInfo- | |
| | | 1000) | |
| OperMode | 0 | MS Based Mode (MS Based | |
| | | Preferred) | |
| | 1 | Network Only (MS Assisted Only) | |
| | 2 | Speed Optimized (MS Assisted + MS | |
| | | Based) | |
| | 3 | Accuracy Optimized (MS Assisted | |
| | | Preferred) | |
| SessionType | 0 | Latest result. Without navigating | |
| | | new GPS location, deliver the | |
| | | latest data which was saved in | |
| | | the memory. If there is no recent | |
| | | location data, send TBD value. | |
| | 1 | Single Shot. (Search GPS signal | |
| | | one time) | |
| | 2 | Tracking Mode. (Search GPS | |
| | | signal multiple times) | |
| | 3 | Data Download. (Session that | |
| | | update the satellite information | |
| | | periodically) | |
| FixNum | Integer | Number of times that OEM needs | |
| | | to search for GPS signal | |
| FixPeriod | Integer | Period of time for navigating | |
| | | location. 0~1800 sec. | |
| Privacy | 0 | Lowest Privacy—Providing MS | |
| | | location info | |
| | 1 | Providing PPM, not providing MS | |
| | | Location (Only apply to MS | |
| | | based) | |
| | 2 | Top Privacy—Not providing MS | |
| | | info | |

In one embodiment, the application platform may be a WIPI (Wireless Internet Platform) platform that is adapted for obtaining location information in real time. Those skilled in the art will appreciate that other programming languages, function calls, mobile application development environment, (e.g. BREW®, Java®, Symbian®, Linux®, Windows Mobile®, etc.) and data structure may be used to implement the same process to obtain location information on a mobile device.

As discussed previously with respect to FIG. 2, the location determination module is adapted to communicate with an external location-based service and obtain real time location data of the mobile device based on the device's cell_ID or using other methods. In one embodiment, the location determination module has an embedded GPS chipset which allows it to communicate with the GPS satellites to obtain latitude, longitude and altitude coordinates of the current position of the device (Step 311). In another embodiment, a Wi-Fi compatible location determination module obtains location information based on its distance from Wi-Fi hotspots. If the mobile device is outside the location based service network or fails to obtain the current location data for any other reasons, the location determination module of the device returns an error message to the processor which, in response, instructs the browser to display a service unavailable message to the user (Step 309). The browser may still permit the user to submit a location-independent search via the mobile network.

If the GPS query is successful, the location determination module forwards the GPS coordinates to the browser and the coordinators are captured in programmatic container (Step 305). The programmatic container may be special XHTML entities, for example, “&lat” and “&lon” for the latitude and the longitude coordinates, respectively, according to the ISO 6709 standard for reference by any markup interpretation during a browser session. In this embodiment, the entities “&lat” and “&lon” are typically declared in the markup page, in conformance to the XML 1.0 specification, for the browser to incorporate them in a search query (Step 312). In addition, if GPS is used to obtain the location coordinates, the connection between the application platform in the location determination module and the GPS are typically terminated after the platform receives the information. The disconnecting has to be done before the browser is closed in order to avoid network socket resource conflict. In one embodiment, the function MC_ioDevCloseo is called as follows, to break the connection:

M_Int32 OEMC_ioDevClose(M_Int32 fd)

Other similar functions and data structures may be used in different embodiments to achieve the same results. If the GPS query is unsuccessful or unnecessary for any reason, the location determination module may pass a cached location value for that particular search or for multiple searches.

After the location information is stored in the programmatic container, the programmatic container may be sent to a third party content server as a part of the search query to conduct a point-of-interest search (Step 306). The search query may also include user specified search terms from the search page. The search terms and the programmatic container containing location data may be combined and formatted as a part of a HTTP POST for submission to the content server. The following is an example of a XHTML markup that employs the entities discussed above for a link to obtain a WAP-based map of the user's current locations:

```
<p>
  <a href=“http://searchprovider.com/mapdetail?lat=&lat;&amp;lon=
  &lon:”>
      [Click here for a WAP-based map of my current location]
  </a>
</p>
```

Upon receiving the search query, the content server extracts the search terms and location data from the container, reformats the query if necessary, and retrieves point-of-interest information from a data repository based on the search terms and the location data (Step 307). Preferably, the content server is indexed relative to the location coordinates so that the latitude and longitude data can be easily converted to zip code of street address to be used in a database search. In one embodiment, even if the user does not specifically request for a location-sensitive search, the content server automatically sorts the search results based on their proximity to the user location based on the location coordinates it receives.

The content server then sends the search results back to the mobile device via the wireless network. Upon receiving the search results, the browser automatically refreshes the page to display the retrieved information (Step 308). The search results may also each include a link to a more detailed page on the particular result.

As illustrated in FIG. 3, embodiments of the invention provide a manageable solution for mobile device users to conduct location based searching by reducing the required amount of user interactions. Specifically, the invention utilizes the existing location determination capability of a mobile device and automatically incorporates the location information in a search without significant user input. Accordingly, in one embodiment the required user action only includes opening a browser on the mobile device and selecting the search page. In another embodiment, the required user action includes modeless entry of a search string followed by an agreement to use location information when performing a search such the modeless entry triggers the search process. The user may optionally enter a search term to better define the scope of the search. To that end, the present invention gives users the freedom to customize their searches and potentially allow them to search for anything available on the Internet. This is an obvious advantage over existing navigation system with point-of-interest search capability, which is limited by the number of categories and available data.

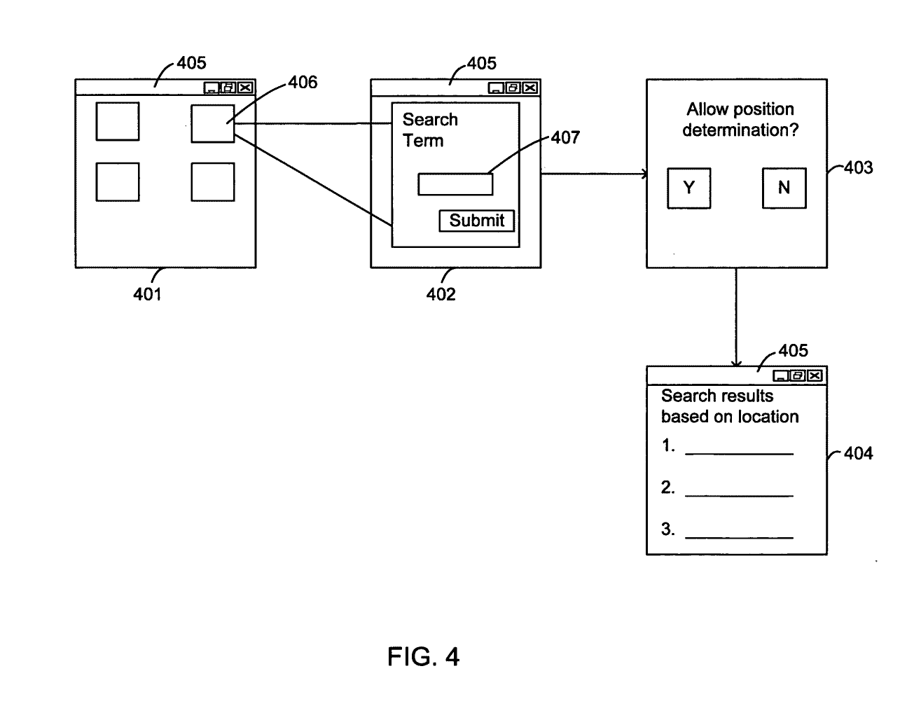

FIG. 4 is a series of exemplary screen shots illustrating, from a user's perspective, the steps of conducting a location based search on a mobile device, in accordance with an embodiment of the present invention. The first screen 401 illustrates a default page displayed in a browser 405, the default page having a number of different icons representing the most frequent visited links by the user of the device. One of the icons 406 opens up the search page 402 in the browser. The search page includes a text box 407 for the user to enter one or more search terms. However, if no search term is specified in the text box, the device may by default display a map of its current location, the current local weather information, up-to-date local news or any other types of location based information. In one embodiment, the search box can be available at all times on the idle screen. In yet another embodiment, the searching is initiated by using a modeless search query implementation such that typing a search term during idle mode triggers the point of interest searching described herein.

The third screen may be a popup window positioned relative to the browser 405 or the next screen after the user submits a search term on the search page 402. In this embodiment, the user is required to authorize location determination and the disclosing of such information to a third party. By clicking on the “Yes” button on the third screen 403, the user allows the browser 405 to obtain the real time location information of the mobile device and transmit the location information with the user specified search term to a remote content server through a wireless network. Details of how location information is acquired and search query is formed and transmitted is discussed above in view of FIG. 3. By clicking on the “No” button, the user prevents the device from obtaining and transmitting its location information. Consequently, in one embodiment, the search may be only based on an input search term.

If the search query generates at least one result from the content server, the result is received and displayed in the browser 405, as shown in screen shot 404. If more than one result is displayed, the results may be sorted based on their relevance to the search term and/or their proximity with respect to the current location of the mobile device. More information on each result may be retrieved from the content server by clicking on the link associated with each of them.

In another embodiment, a user of a mobile device first selects a browser-based location application on the default page in a browser displayed on the screen on the mobile device. The container and content server embodiments can be used to support the widget based embodiment. Similar to the previous embodiment, the user is immediately prompted to authorize the device to obtain location information. If the user denies the request by clicking on the “No” button, the browser reloads the default page. If request is granted by the user, location information (e.g., cell_ID, GPS coordinates) is automatically obtained by the device and processed to generate other location-dependent information, such as local weather information as shown on the next screen

Optionally, a map showing the current location of the device is available upon request where the location is also determined by using the GPS coordinates obtained by the device. This enables real time information of interest to a user that is organized by web-based widgets based on the methods described above.

Those of ordinary skill in the art will readily appreciate that mobile device is exemplary only and that the present invention can operate within a number of different mobile devices. Furthermore, various embodiments of the present invention described above may be implemented at any level, ranging from hardware to application software and in any appropriate physical location or operating system.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method of conducting a search on a mobile device, the mobile device capable of communicating with a content server, the method comprising the steps of:
initiating a search query using a browser on the mobile device, the search query having a search string;
automatically obtaining location information of the mobile device;
simultaneously transmitting the location information and the search query to the content server; and
receiving a search result from the content server in response to the search query,
wherein the step of automatically obtaining location information is in response to the step of initiating the search query.

2. The method of claim 1 further comprising the step of incorporating user defined search terms in the search query.

3. The method of claim 1 wherein the step of initiating a search further comprises the steps of:
opening the browser on the mobile device; and
clicking on a link displayed on the browser.

4. The method of claim 1 wherein the location information is in the format of GPS coordinates.

5. The method of claim 1 wherein the location information of the mobile device is based on the Cell ID of the mobile device.

6. The method of claim 1 wherein the location information is stored on the mobile device.

7. The method of claim 1 further comprising the step of obtaining user consent for using the location information of the mobile device in the search.

8. The method of claim 1 wherein the location information comprises the current location information of the mobile device.

9. The method of claim 1 wherein the location information comprises cached location information of the mobile device.

10. A mobile device adapted to conduct a location based search, the mobile device capable of communicating with a content provider, the mobile device comprising:
a browser for initiating a search query;
a location determining module for obtaining location information of the mobile device, the location determination module is in communication with the browser;
a data formatting module for formatting the location information and incorporating the formatted location information in the search query; and
a communication module for transmitting the search query to the content provider and receiving a search result from the content provider.

11. The mobile device of claim 10 further comprises a user input module adapted to receive user defined search terms.

12. The mobile device of claim 10 wherein the location information is in the format of GPS coordinates.

13. The mobile device of claim 10 wherein the location information of the mobile device is based on the Cell ID of the mobile device.

14. The mobile device of claim 10 wherein the location information of the mobile device is stored on the mobile device.

15. The mobile device of claim 10 further comprises a user consent verification module for verifying user consent for using the location information of the mobile device in the search.

16. A method of conducting a search using a browser on a mobile device, the mobile device capable of communicating with a content server, the method comprising the steps of:
entering a search query at a search prompt;
automatically obtaining location information of the mobile device in response to entry of the search query;
storing the location information and search query in a container;
transmitting the container to the content server;
querying the content server for point of interest data based on contents of container; and
retrieving point of interest data from the content server.

17. The method of 16 further comprising the step of obtaining user consent for using the location information of the mobile device in the search.

18. The method of 16 further comprising the step of:
converting the location information into a converted format.

19. The method of 18 wherein the converted format is a XML entity.

20. The method of 18 wherein the converted format comprises GPS coordinates.
